(19) United States
(12) Patent Application Publication
(10) Pub. No.: US 2026/0152625 A1
(43) Pub. Date: Jun. 4, 2026

(54) RAW MATERIAL COMPOSITION OF THERMOPLASTIC PRODUCT MIXED WITH MICROALGAE, PRODUCT THEREOF AND PREPARATION METHOD THEREFOR

(71) Applicant: ECO RESEARCH SDN. BHD., Simpang Ampat (MY)

(72) Inventors: Chee Wei CHAN, Kallang (SG); Kah Aik TAN, Kallang (SG); Kee Chung HUI, Kallang (SG)

(21) Appl. No.: 19/123,036

(22) PCT Filed: Oct. 17, 2023
(86) PCT No.: PCT/SG2023/050700

§ 371 Date: Apr. 21, 2025

Related U.S. Application Data
(60) Provisional application No. 63/417,375, filed on Oct. 19, 2022.

(51) Int. Cl. C08K 5/00; C08K 5/11

(52) U.S. Cl. CPC C08K 11/00; B29B 13/06; B29B 13/10; C08K 5/053; C08K 5/06; C08K 5/098; C08K 5/55; B29K 2029/04; B29K 2105/0038; B29K 2995/006; C08K 2201/018

(57) ABSTRACT

A raw material composition of a thermoplastic product mixed with microalgae, a product thereof and a preparation method therefor. The composition includes polyvinyl alcohol, microalgae, a compatilizer, a plasticizer, a cross-linking agent, a reaction aid and a lubricating agent. The weight percentage of the microalgae on the basis of the weight of the polyvinyl alcohol is between 10% and 30%; the weight percentage of the compatilizer on the basis of the weight of the polyvinyl alcohol is between 2% and 5%; the weight percentage of the plasticizer on the basis of the weight of the polyvinyl alcohol is between 20% and 30%; the weight percentage of the cross-linking agent on the basis of the weight of the polyvinyl alcohol is between 0% and 1.5%; the weight percentage of the reaction aid on the basis of the weight of the polyvinyl alcohol is between 1% and 5%; and the weight percentage of the lubricating agent on the basis of the weight of the polyvinyl alcohol is between 0.1% and 0.5%.

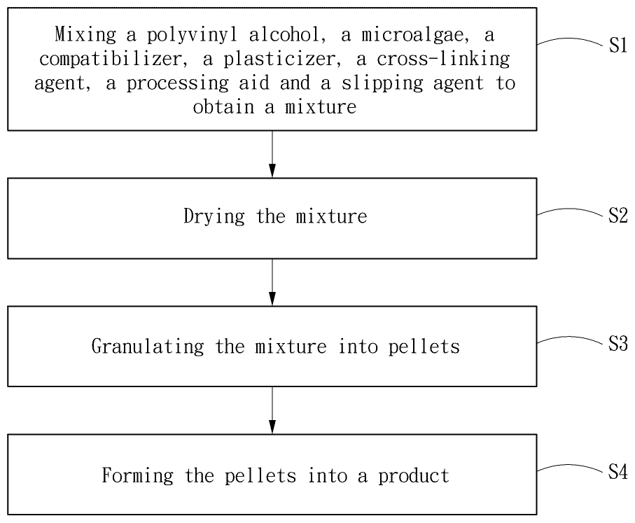

### FIELD OF THE INVENTION

The present invention relates to a raw material composition for thermoplastic products mixed with microalgae, and more particularly to a raw material composition for thermoplastic products mixed with microalgae, the products thereof, and the preparation method therefor.

### BACKGROUND OF THE INVENTION

Reducing and eliminating plastic waste is a global goal and challenge, with biodegradable plastics being a primary solution. Among biodegradable plastics, oxo-degradable plastics require specific degradation conditions and lack consistent evidence regarding their environmental decomposition rates, leading to their gradual prohibition by official entities such as the European Union. Meanwhile, natural-source plastics like starch-based composites hold significant potential for widespread applications but may raise concerns about competition with food resources. Therefore, developing functional bioplastics and composites that meet requirements for biodegradability; water solubility, favorable mechanical properties, and thermal performance become a crucial area of focus.

In the realm of biodegradable plastic raw materials, microalgae offer immense potential due to their rapid production, simple cultivation, and minimal impact on the food chain, making them suitable as polymer fillers in plastic production.

### SUMMARY OF THE INVENTION

The present invention provides a raw material composition for a thermoplastic product mixed with microalgae, the raw material composition comprising a polyvinyl alcohol, a microalgae, a compatibilizer, a plasticizer, a cross-linking agent, a processing aid, and a slipping agent. The microalgae is present in an amount of from 10% to 30% by weight based on the weight of the polyvinyl alcohol, the compatibilizer is present in an amount of from 2% to 5% by weight based on the weight of the polyvinyl alcohol, the plasticizer is present in an amount of from 20% to 30% by weight based on the weight of the polyvinyl alcohol, the cross-linking agent is present in an amount of from 0% to 1.5% by weight based on the weight of the polyvinyl alcohol, the processing aid is present in an amount of from 1% to 5% by weight based on the weight of the polyvinyl alcohol, and the slipping agent is present in an amount of from 0.1% to 0.5% by weight based on the weight of the polyvinyl alcohol.

In one embodiment, the composition further comprises a toughening agent in an amount of from 0.2% to 0.5% by weight based on the weight of the polyvinyl alcohol.

In one embodiment, the degree of polymerization of the polyvinyl alcohol is between 300 and 2400.

In one embodiment, the hydrolysis degree of the polyvinyl alcohol is between 88% and 99%.

In one embodiment, the protein content of the microalgae is not less than 30%.

In one embodiment, the microalgae is selected from the group consisting of Spirulina sp., Chlorella sp., Nannochloropsis sp., Dunaliella sp., Tetraselmis sp., or combinations thereof.

In one embodiment, the plasticizer is a polyol.

In one embodiment, the polyol is selected from the group consisting of glycerol, polyethylene glycol, sorbitol, xylitol, mannitol, or combinations thereof.

In one embodiment, the compatibilizer is gum rosin.

In one embodiment, the cross-linking agent is selected from the group consisting of boric acid, citric acid, adipic acid, succinic acid, or suberic acid.

In one embodiment, the processing aid is a lubricant.

In one embodiment, the slipping agent comprises an alkali metal stearate.

According to one aspect, the present invention further provides a thermoplastic product mixed with microalgae, made from the raw material composition described above.

According to one aspect, the present invention further provides a method for preparing a thermoplastic product mixed with microalgae, comprising the steps of: mixing a polyvinyl alcohol, a microalgae, a compatibilizer, a plasticizer, a cross-linking agent, a processing aid, and a slipping agent to obtain a mixture, wherein the microalgae is present in an amount of from 10% to 30% by weight based on the weight of the polyvinyl alcohol, the compatibilizer is present in an amount of from 2% to 5%, the plasticizer in an amount of from 20% to 30%, the cross-linking agent in an amount of 0% to 1.5%, the processing aid in an amount of from 1% to 5%, and the slipping agent in an amount of from 0.1% to 0.5%, all percentages by weight based on the polyvinyl alcohol; drying the mixture; granulating the mixture into pellets; and forming the pellets into a product.

### BRIEF DESCRIPTION OF THE DRAWINGS

Example embodiments of the present disclosure will be described with reference to the accompanying drawings briefly described below:

The sole FIGURE illustrates a flowchart of steps according to an embodiment of the present invention.

### DETAILED DESCRIPTION

It should be understood that although some embodiments execute steps in a specific order, these steps may also be performed in another reasonable sequence. For different embodiments or examples, certain features described below may be substituted or omitted. It should be understood that some additional operations may be performed before, during, or after the described methods, and in other embodiments of the method, certain operations may be replaced or omitted.

Unless otherwise specified, all numerical values of dimensions, quantities, and physical properties used herein and in the claims should be understood as being modified by the term “approximately” in all instances. Thus, unless indicated to the contrary; the numerical parameters listed herein and in the claims are approximate values, which those skilled in the art can appropriately adjust to achieve the desired properties disclosed herein. The use of numerical ranges expressed by endpoints includes all values within that range and any sub-range therein; for example, 1 to 5 includes values such as 1, 1.2, 1.5, 1.7, 2, 2.75, 3, 3.80, 4, and 5.

The present disclosure relates to a raw material composition for thermoplastic products mixed with microalgae, primarily using protein-rich microalgae as a filler. The raw material composition also includes water-soluble additives containing polyvinyl alcohol, which may be soluble in cold water or hot water. In one example, the raw material composition comprises a polyvinyl alcohol, a microalgae, a compatibilizer, a plasticizer, a cross-linking agent, a processing aid, and a slipping agent. In another example, the composition may optionally further include a toughening agent.

In terms of proportions, the microalgae is present in an amount of 10% to 30% by weight based on the weight of the polyvinyl alcohol, the compatibilizer is present in an amount of 2% to 5% by weight based on the weight of the polyvinyl alcohol, the plasticizer is present in an amount of 20% to 30% by weight based on the weight of the polyvinyl alcohol, the cross-linking agent is present in an amount of 0% to 1.5% by weight based on the weight of the polyvinyl alcohol, the processing aid is present in an amount of 1% to 5% by weight based on the weight of the polyvinyl alcohol, the slipping agent is present in an amount of 0.1% to 0.5% by weight based on the weight of the polyvinyl alcohol, and the toughening agent is present in an amount of 0.2% to 0.5% by weight based on the weight of the polyvinyl alcohol.

In one example, the microalgae is present in an amount of 10%±0.5%, 12%±0.5%, 15%±0.5%, or 18%±0.5% by weight based on the weight of the polyvinyl alcohol, the compatibilizer is present in an amount of 2%±0.5%, 3%±0.5%, 4%±0.5%, or 5%±0.5%; the plasticizer is present in an amount of 16%±0.5%, 20%±0.5%, 24%±0.5%, or 25%±0.5%, the cross-linking agent is present in an amount of 0% (i.e., no cross-linking agent added), 0.2%±0.1%, 0.3%±0.1%, or 0.5%±0.1%, the processing aid is present in an amount of 3.4%±0.5%, 3.6%±0.5%, 4%±0.5%, or 5%±0.5%, the slipping agent is present in an amount of 0.2%±0.1%, 0.3%±0.1%, or 0.4%±0.1%, and the toughening agent is present in an amount of 0.2%±0.1% or 0.4%±0.1%, all percentages by weight based on the weight of the polyvinyl alcohol.

The microalgae used are protein-rich, with a protein content of at least 30%, such as Spirulina sp., Chlorella sp., Nannochloropsis sp., Dunaliella sp., Tetraselmis sp., or combinations thereof.

In terms of properties, in one example, the degree of polymerization of the polyvinyl alcohol ranges from 300 to 2400. If the degree of polymerization is relatively low, the melting point and melt viscosity are lower, resulting in a final product with lower Young's modulus and tensile strength but higher elongation at break. Conversely, if the degree of polymerization is relatively high, the melting point and melt viscosity are higher, leading to a final product with higher Young's modulus and tensile strength but lower elongation at break. Therefore, the degree of polymerization of the polyvinyl alcohol is desired to be within an appropriate limit.

The degree of hydrolysis of the polyvinyl alcohol ranges from 88% to 99%. For example, polyvinyl alcohol with a degree of hydrolysis of 88%, such as models PVA-0588, PVA-1788, PVA-2088, PVA-2288, or PVA-2488, or with a degree of hydrolysis of 99%, such as models PVA-0599, PVA-1799, PVA-2099, PVA-2299, or PVA-2499, may be used. If the degree of hydrolysis is relatively high, e.g., 99%, the final product requires a higher water temperature (around 50° C.) to decompose but exhibits better heat resistance during use. If the degree of hydrolysis is relatively low, e.g., 88%, the final product may be decomposed in the room-temperature water but has poorer heat resistance during use. Thus, the degree of hydrolysis of the polyvinyl alcohol is desired to be within an appropriate limit.

Since the melting point of polyvinyl alcohol is close to its decomposition temperature, thermal processing of polyvinyl alcohol is generally challenging. Therefore, the plasticizer may be appropriately added to widen the processing window, improving the processability and flexibility of the product. The plasticizer may be a polyol, such as glycerol, polyethylene glycol, sorbitol, xylitol, or mannitol. In some examples, low-molecular-weight polyols may be selected, as they have better penetrability and can help fill gaps between molecular chains.

To enhance compatibility and melt blending between the polyvinyl alcohol and the microalgae, a compatibilizer is suggested to be further added. The compatibilizer may be a natural material, such as gum rosin, which improves a inter-facial adhesion between the polyvinyl alcohol and the microalgae, resulting in better mechanical and thermal properties of the product.

The cross-linking agent may be selected from compounds with multifunctional groups capable of reacting with the polyvinyl alcohol and the microalgae, such as boric acid, citric acid, adipic acid, succinic acid, or suberic acid. The processing aid may be a lubricant, such as stearic acid and/or polyethylene oxide. Alternatively or additionally, internal lubricants like myristic acid, palmitic acid, or stearic acid, or external lubricants like polyethylene oxide may be used as the processing aid. The slipping agent may be an alkali metal stearate acid, such as sodium stearate or potassium stearate.

According to various embodiments, each ingredient of the raw material composition may include one or more species. For example, the polyvinyl alcohol may be a single species or a combination of two or more species, such as a combination of PVA-0588 and PVA-1788 or PVA-0599 and PVA-1799. The microalgae may be a single genus or a combination of two or more genera, such as a combination of Spirulina sp. and Nannochloropsis sp. Similarly, the compatibilizer, the plasticizer, the cross-linking agent, the processing aid, and the slipping agent may be a single species or a combination of two or more species.

The sole FIGURE is a flowchart illustrating the steps of a preparation method according to one embodiment of the present invention, comprising the following steps. First, a polyvinyl alcohol, a microalgae, a compatibilizer, a plasticizer, a cross-linking agent, a processing aid, and a slipping agent are mixed to obtain a homogeneous mixture (Step S1), with the raw material composition proportions as described above. The mixture is then dried (Step S2), followed by pelletization (Step S3). Finally, the pellets are shaped into the desired product (Step S4). In one example, the mixture may further include a toughening agent.

The following experimental examples are provided to describe the present invention more specifically. However, the experimental examples of the present invention are not limited to the content below and may be appropriately modified.

Table 1 shows the raw materials and their proportions used in Experimental Examples 1 to 6, while Table 2 shows the raw materials and their proportions used in Experimental Examples 7 to 12.

In Experimental Examples 1 to 8, the raw materials were first mixed in a mixer at 300 rpm for approximately 3 minutes, followed by mixing at 800 rpm for approximately 5 minutes, yielding a mixture. The mixture was then dried at 55° C. for about 24 hours. The dried mixture was granulated into pellets using an extrusion pelletizing machine, and subsequently processed into plastic films using a blown film machine.

In Experimental Example 1, the temperature profile for the extrusion process from Zone 1 to the die head was sequentially 165° C., 165° C., 180° C., 185° C., 190° C., 185° C., 180° C., 170° C., and 165° C. The temperature profile for the blown film process from Zone 1 to the die head was sequentially 185° C., 193° C., 205° C., 205° C., and 185° C.

In Experimental Example 2, the temperature profile for the extrusion process from Zone 1 to the die head was sequentially 175° C., 175° C., 190° C., 195° C., 200° C., 195° C., 190° C., 180° C., and 175° C. The temperature profile for the blown film process from Zone 1 to the die head was sequentially 195° C., 203° C., 215° C., 215° C., and 195° C.

In Experimental Example 3, the temperature profile for the extrusion process from Zone 1 to the die head was sequentially 175° C., 175° C., 190° C., 195° C., 200° C., 195° C., 190° C., 180° C., and 175° C. The temperature profile for the blown film process from Zone 1 to the die head was sequentially 190° C., 198° C., 210° C., 210° C., and 190° C.

In Experimental Example 4, the temperature profile for the extrusion process from Zone 1 to the die head was sequentially 185° C., 185° C., 200° C., 205° C., 210° C., 205° C., 200° C., 190° C., and 185° C. The temperature profile for the blown film process from Zone 1 to the die head was sequentially 195° C., 203° C., 215° C., 215° C., and 195° C.

In Experimental Examples 5 to 7, the temperature profile for the extrusion process from Zone 1 to the die head was sequentially 165° C., 165° C., 180° C., 185° C., 190° C., 185° C., 180° C., 170° C., and 165° C. The temperature profile for the blown film process from Zone 1 to the die head was sequentially 185° C., 193° C., 205° C., 205° C., and 185° C.

In Experimental Example 8, the temperature profile for the extrusion process from Zone 1 to the die head was sequentially 175° C., 185° C., 200° C., 205° C., 210° C., 205° C., 200° C., 190° C., and 185° C. The temperature profile for the blown film process from Zone 1 to the die head was sequentially 185° C., 193° C., 205° C., 205° C., and 185° C.

In Experimental Examples 9 to 12, the raw materials were first mixed in a mixer at 300 rpm for approximately 5 minutes, followed by mixing at 800 rpm for approximately 3 minutes, yielding a mixture. The mixture was then dried at 55° C. for about 24 hours. The dried mixture was formed into pellets using a twin-screw extruder, and subsequently processed into dumbbell-shaped plastic products using an injection molding machine (model BOY 22M).

In Experimental Example 9, the temperature profile for the extrusion process from Zone 1 to the die head was sequentially 165° C., 165° C., 180° C., 185° C., 190° C., 185° C., 180° C., 170° C., and 165° C. The temperature profile for the injection molding process from Zone 1 to Zone 3 was sequentially 165° C., 175° C., and 175° C., with a nozzle temperature of 170° C., holding pressure set sequentially at 30 (bar)-40 (bar)-50 (bar), and back pressure set sequentially at 40 (bar)-60 (bar).

In Experimental Example 10, the temperature profile for the extrusion process from Zone 1 to the die head was sequentially 175° C., 175° C., 190° C., 195° C., 200° C., 195° C., 190° C., 180° C., and 175° C. The temperature profile for the injection molding process from Zone 1 to Zone 3 was sequentially 185° C., 195° C., and 195° C., with a nozzle temperature of 190° C., holding pressure set sequentially at 65 (bar)-75 (bar)-85 (bar), and back pressure set sequentially at 80 (bar)-100 (bar).

In Experimental Example 11, the temperature profile for the extrusion process from Zone 1 to the die head was sequentially 175° C., 175° C., 190° C., 195° C., 200° C., 195° C., 190° C., 180° C., and 175° C. The temperature profile for the injection molding process from Zone 1 to Zone 3 was sequentially 185° C., 195° C., and 195° C., with a nozzle temperature of 190° C., holding pressure set sequentially at 30 (bar)-40 (bar)-50 (bar), and back pressure set sequentially at 40 (bar)-60 (bar).

In Experimental Example 12, the temperature profile for the extrusion process from Zone 1 to the die head was sequentially 185° C., 195° C., 210° C., 215° C., 220° C., 215° C., 210° C., 200° C., and 195° C. The temperature profile for the injection molding process from Zone 1 to Zone 3 was sequentially 185° C., 205° C., and 205° C., with a nozzle temperature of 195° C., holding pressure set sequentially at 40 (bar)-50 (bar)-60 (bar), and back pressure set sequentially at 60 (bar)-80 (bar).

The plastic film product from Experimental Example 8 was tested for tensile strength according to the ASTM D882 standard, while the products from Experimental Examples 9 to 12 were tested for tensile strength according to the ASTM D638 standard, with results shown in Table 3.

From the mechanical property measurement results, it can be observed that, based on the raw material composition disclosed in the present invention, materials with various mechanical properties can be produced through appropriate proportion adjustments, enabling applications for various needs. For example, the film product from Experimental Example 8 exhibits excellent ductility and a certain level of strength, while the plastic product from Experimental Example 12 demonstrates good mechanical strength.

TABLE 1

| | | | | | | cross- | | | |
|---|---|---|---|---|---|---|---|---|---|
| | | | | | | linking | | slipping | toughening |
| Run No. | Compositions | polyvinyl alcohol | microalgae | compatibilizer | plasticizer | agent | processing aid | agent | agent |

| | | | | | | | | | | |
|---|---|---|---|---|---|---|---|---|---|---|
| Experimental | Components | PVA-0588 | Spirulina sp. | gum rosin | glycerol | boric | stearic | polyethylene | sodium | — |
| Example 1 | | | | | | acid | acid | oxide | stearate | |
| | Weight (g) | 100 | 18 | 2 | 20 | 0.5 | 1 | 2.4 | 0.2 | — |
| | Weight | 69.40% | 12.49% | 1.39% | 13.88% | 0.35% | 0.69% | 1.67% | 0.14% | |
| | Percent | | | | | | | | | |
| Experimental | Components | PVA-1788 | Spirulina sp. | gum rosin | glycerol | boric | stearic | polyethylene | sodium | — |
| Example 2 | | | | | | acid | acid | oxide | stearate | |
| | Weight (g) | 100 | 15 | 2 | 24 | 0.2 | 1.5 | 3 | 0.2 | — |
| | Weight | 68.54% | 10.28% | 1.37% | 16.45% | 0.14% | 1.03% | 2.06% | 0.14% | — |
| | Percent | | | | | | | | | |

| | | | | | | | | | | | |
|---|---|---|---|---|---|---|---|---|---|---|---|
| Experimental | Components | PVA-0588 | PVA-1788 | Spirulina sp. | gum rosin | glycerol | boric | stearic | polyethylene | sodium | — |
| Example 3 | | 60 | 40 | | | | acid | acid | oxide | stearate | |
| | Weight (g) | 41.93% | 27.95% | 12 | 2 | 25 | 0.3 | 1 | 2.6 | 0.2 | — |

| | | | | | | | | | | |
|---|---|---|---|---|---|---|---|---|---|---|
| | Weight | | 8.39% | 1.40% | 17.47% | 0.21% | 0.70% | 1.82% | 0.14% | — |
| | Percent | | | | | | | | | |
| Experimental | Components | PVA-2088 | Spirulina sp. | gum rosin | glycerol | boric | stearic | polyethylene | sodium | — |
| Example 4 | | | | | | acid | acid | oxide | stearate | |
| | Weight (g) | 100 | 10 | 2 | 24 | 0.5 | 1 | 4 | 0.2 | — |
| | Weight | 70.57% | 7.06% | 1.41% | 16.94% | 0.35% | 0.71% | 2.82% | 0.14% | — |
| | Percent | | | | | | | | | |
| Experimental | Components | PVA-0588 | Chlorella sp. | gum rosin | glycerol | boric | stearic | polyethylene | sodium | — |
| Example 5 | | | | | | acid | acid | oxide | stearate | |
| | Weight (g) | 100 | 18 | 2 | 20 | 0.5 | 1 | 2.4 | 0.2 | — |
| | Weight | 69.40% | 12.49% | 1.39% | 13.88% | 0.35% | 0.69% | 1.67% | 0.14% | — |
| | Percent | | | | | | | | | |
| Experimental | Components | PVA-0588 | Nannochloropsis sp. | gum rosin | glycerol | boric | stearic | polyethylene | sodium | — |
| Example 6 | | | | | | acid | acid | oxide | stearate | |
| | Weight (g) | 100 | 18 | 2 | 20 | 0.5 | 1 | 2.4 | 0.2 | — |
| | Weight | 69.40% | 12.49% | 1.39% | 13.88% | 0.35% | 0.69% | 1.67% | 0.14% | — |
| | Percent | | | | | | | | | |

TABLE 2

| | | | | | | cross- | | | | |
|---|---|---|---|---|---|---|---|---|---|---|
| | | polyvinyl | | compat- | | linking | | | slipping | toughening |
| Run No. | Compositions | alcohol | microalgae | ibilizer | plasticizer | agent | processing aid | | agent | agent |
| Experimental | Components | PVA-0588 | Nannochloropsis | gum rosin | glycerol | boric | stearic | polyethylene | sodium | — |
| Example 7 | | | sp. L | | | acid | acid | oxide | stearate | |
| | Weight (g) | 100 | 18 | 2 | 20 | 0.5 | 1 | 2.4 | 0.2 | — |
| | Weight | 69.40% | 12.49% | 1.39% | 13.88% | 0.35% | 0.69% | 1.67% | 0.14% | — |
| | Percent | | | | | | | | | |
| Experimental | Components | PVA-0588 | Spirulina sp. | gum rosin | glycerol | — | stearic | polyethylene | sodium | CNF |
| Example 8 | | | | | | | acid | oxide | stearate | |
| | Weight (g) | 100 | 12 | 2 | 24 | — | 1 | 3 | 0.2 | 0.2 |
| | Weight | 70.22% | 8.43% | 1.40% | 16.85% | — | 0.70% | 2.11% | 0.14% | 0.14% |
| | Percent | | | | | | | | | |
| Experimental | Components | PVA-0588 | Spirulina sp. | gum rosin | glycerol | — | stearic | \|polyethylene | sodium | — |
| Example 9 | | | | | | | acid | oxide | stearate | |
| | Weight (g) | 100 | 12 | 2 | 24 | — | 1 | 3 | 0.2 | — |
| | Weight | 70.32% | 8.44% | 1.41% | 16.88% | — | 0.70% | 2.11% | 0.14% | — |
| | Percent | | | | | | | | | |
| Experimental | Components | PVA-0599 | Spirulina sp. | gum rosin | glycerol | — | stearic | polyethylene | sodium | — |
| Example 10 | | | | | | | acid | oxide | stearate | |
| | Weight (g) | 100 | 12 | 2 | 24 | — | 1 | 3 | 0.2 | — |
| | Weight | 70.32% | 8.44% | 1.41% | 16.88% | — | 0.70% | 2.11% | 0.14% | — |
| | Percent | | | | | | | | | |
| Experimental | Components | PVA-0588 | Spirulina sp. | gum rosin | glycerol | boric | stearic | polyethylene | sodium | — |
| Example 11 | | | | | | acid | acid | oxide | stearate | |
| | Weight (g) | 100 | 12 | 2 | 24 | 0.5 | 1 | 3 | 0.2 | — |
| | Weight | 70.08% | 8.41% | 1.40% | 16.82% | 0.35% | 0.70% | 2.10% | 0.14% | — |
| | Percent | | | | | | | | | |
| Experimental | Components | PVA-0599 | Spirulina sp. | gum rosin | glycerol | — | stearic | polyethylene | sodium | — |
| Example 12 | | | | | | | acid | oxide | stearate | |
| | Weight (g) | 100 | 12 | 2 | 16 | — | 1 | 3 | 0.2 | — |
| | Weight | 74.52% | 8.94% | 1.49% | 11.92% | — | 0.75% | 2.24% | 0.15% | — |
| | Percent | | | | | | | | | |

TABLE 3

| | Tensile | | Young's |
|---|---|---|---|
| | Strength | Elongation | Modulus |
| Run No. | (MPa) | (%) | (MPa) |
| Experimental | 8.287 | 112.46 | 47.292 |
| Example 8 | | | |
| Experimental | 20.874 | 225.82 | 306.94 |
| Example 9 | | | |
| Experimental | 33.888 | 33.42 | 777.195 |
| Example 10 | | | |
| Experimental | 28.805 | 187.2 | 638.046 |
| Example 11 | | | |
| Experimental | 52.969 | 0.41 | 1762.711 |
| Example 12 | | | |

1. A raw material composition for a thermoplastic product mixed with a microalgae, the raw material composition comprising:
a polyvinyl alcohol;
the microalgae in an amount of from 10% to 30% by weight based on the weight of the polyvinyl alcohol;
a compatibilizer in an amount of from 2% to 5% by weight based on the weight of the polyvinyl alcohol;
a plasticizer in an amount of from 20% to 30% by weight based on the weight of the polyvinyl alcohol;
a cross-linking agent in an amount of from 0% to 1.5% by weight based on the weight of the polyvinyl alcohol;
a processing aid in an amount of from 1% to 5% by weight based on the weight of the polyvinyl alcohol; and
a slipping agent in an amount of from 0.1% to 0.5% by weight based on the weight of the polyvinyl alcohol.

2. The raw material composition according to claim 1, wherein further comprises a toughening agent in an amount of from 0.2% to 0.5% by weight based on the weight of the polyvinyl alcohol.

3. The raw material composition according to claim 1, wherein a degree of polymerization of the polyvinyl alcohol is between 300 and 2400.

4. The raw material composition according to claim 1, wherein a hydrolysis degree of the polyvinyl alcohol is between 88% and 99%.

5. The raw material composition according to claim 1, wherein a protein content of the microalgae is not less than 30%.

6. The raw material composition according to claim 1, wherein the microalgae is selected from Spirulina sp., Chlorella sp., Nannochloropsis sp., Dunaliella sp., Tetraselmis sp., or combinations thereof.

7. The raw material composition according to claim 1, wherein the plasticizer is a polyol.

8. The raw material composition according to claim 7, wherein the polyol is glycerol, polyethylene glycol, sorbitol, xylitol, mannitol, or combinations thereof.

9. The raw material composition according to claim 1, wherein the compatibilizer is gum rosin.

10. The raw material composition according to claim 1, wherein the cross-linking agent is boric acid, citric acid, adipic acid, succinic acid, or suberic acid.

11. The raw material composition according to claim 1, wherein the processing aid is a lubricant.

12. The raw material composition according to claim 1, wherein the slipping agent comprises an alkali metal stearate.

13. A thermoplastic product mixed with a microalgae, made from the raw material composition according to claim 1.

14. A method for preparing a thermoplastic product mixed with a microalgae, comprising the steps of:
mixing a polyvinyl alcohol, the microalgae, a compatibilizer, a plasticizer, a cross-linking agent, a processing aid, and a slipping agent to obtain a mixture, wherein the microalgae is present in an amount of from 10% to 30% by weight based on the weight of the polyvinyl alcohol, the compatibilizer is present in an amount of from 2% to 5%, the plasticizer in an amount of from 20% to 30%, the cross-linking agent in an amount of 0% to 1.5%, the processing aid in an amount of from 1% to 5%, and the slipping agent in an amount of from 0.1% to 0.5%, all percentages by weight based on the polyvinyl alcohol;
drying the mixture;
granulating the mixture into pellets; and
forming the pellets into a product.
